(19) United States
(12) Patent Application Publication
(10) Pub. No.: US 2025/0105578 A1
(43) Pub. Date: Mar. 27, 2025

(54) OPTICAL FIBER FOR AMPLIFICATION, OPTICAL AMPLIFIER, AND METHOD FOR CONTROLLING OPTICAL AMPLIFIER

(71) Applicant: NIPPON TELEGRAPH AND TELEPHONE CORPORATION, Tokyo (JP)

(72) Inventors: Taiji SAKAMOTO, Musashino-shi, Tokyo (JP); Ryota IMADA, Musashino-shi, Tokyo (JP); Shinichi AOZASA, Musashino-shi, Tokyo (JP); Kazuhide NAKAJIMA, Musashino-shi, Tokyo (JP)

(73) Assignee: NIPPON TELEGRAPH AND TELEPHONE CORPORATION, Tokyo (JP)

(21) Appl. No.: 18/833,531

(22) PCT Filed: Feb. 17, 2022
(86) PCT No.: PCT/JP2022/006383

§ 371 Date: Jul. 26, 2024

(51) Int. Cl. H01S 3/067; H01S 3/094

(52) U.S. Cl. CPC H01S 3/06737; H01S 3/06733; H01S 3/094007

(57) ABSTRACT

An amplification optical fiber according to the present disclosure is an amplification optical fiber doped with a rare earth element, the amplification optical fiber including: a first cladding enclosing cores of the amplification optical fiber; and a second cladding enclosing the first cladding, in which the two or more cores are disposed inside the first cladding in a cross section of the amplification optical fiber, and a core cladding ratio Rcc, which is a ratio of a sum of areas of the two or more cores to a sum of areas of the two or more cores and the first cladding in the cross section of the amplification optical fiber, is 0.0095<Rcc<0.11.

### DESCRIPTION

### Technical Field

The present disclosure relates to an optical fiber amplifier.

### Background Art

In an optical fiber communication system, long-distance transmission is performed by relay while light, suffering a loss, propagating through an optical fiber is amplified by an optical amplifier at every fixed distance. In the amplification in the optical amplifier, signal light and pump light for exciting a rare earth element are injected into an amplification optical fiber in which a core region is doped with the rare earth element (An erbium-doped optical fiber (EDF), using erbium, is mainly adopted.) (Light with 980 nm or 1480 nm is mainly adopted as the pump light in a case of EDF.), and the signal light is amplified without being converted into electricity.

In current communication using a single mode optical fiber (SMF), a core pumping type optical amplifier that amplifies signal light propagating through a core by similarly guiding pump light through the core is used. On the other hand, in recent years, in order to expand transmission capacity of an optical fiber, optical fibers for space division multiplexing (SDM) such as a multicore fiber (hereinafter, may be referred to as an MCF) having a plurality of cores in a cross-section of the optical fiber and a multimode fiber in which two or more modes propagate through the core have been studied, and optical fiber amplifiers applicable to these optical fibers for SDM have been studied (for example, Non Patent Literature 1).

Furthermore, in order to simultaneously amplify plural pieces of signal light propagating through the optical fiber for SDM, a cladding pumping type optical amplifier that guides pump light through a cladding region of the optical fiber has been studied (for example, Non Patent Literature 2). The cladding pumping type optical amplifier can use a multimode light source for pump light, gives power efficiency superior to that of a single mode light source generally used in a core pumping type, does not always require temperature control using a Peltier element necessary for the single mode light source, and is expected to exhibit excellent amplification efficiency.

Compared with the core pumping type optical amplifier, the cladding pumping type optical amplifier has a problem that an amount of pump light to be absorbed into an amplification optical fiber is reduced due to a small overlap between a region through which pump light propagates and a core region through which signal light propagates. To address this problem, studies have examined whether the amount of pump light to be absorbed in the optical fiber is increased by increasing a core cladding ratio Rcc, which is a ratio of a sum of areas of the cores in the optical fiber to a cladding area including the core region, and high amplification efficiency has been demonstrated (for example, Non Patent Literature 3).

However, approach of increasing the amplification efficiency by increasing Rcc as in Non Patent Literature 3 has been studied only for an optical amplifier that amplifies a C band of 1530 to 1565 nm, and an optical amplifier for amplifying an L band of 1565 to 1610 nm, which is one of the low loss communication wavelength bands of the optical fiber, has not clearly displayed a structural condition of the amplification optical fiber for achieving highly efficient amplification.

In general, an erbium-doped optical fiber (EDF) length for amplifying the L band is longer than an EDF length of the C-band amplifier. In this regard, the study report focusing on a non-coupled multicore fiber has shown that an amount of pump light to be absorbed into the whole of the former EDF length is larger than that of the latter in the C-band amplifier due to the long EDF length, and amplification efficiency is improved (for example, Non Patent Literature 4).

However, as described in Non Patent Literature 3, an experimental result in which the amplification efficiency in the L band having a long EDF length decreases even in the same optical fiber structure has also been reported. Thus, the structural condition of the amplification optical fiber, with which the L-band optical amplifier is equipped, is unknown.

### CITATION LIST

### Non Patent Literature

Non Patent Literature 1: Y. Tsuchida et al., “Amplification characteristics of a multi-core erbium-doped fiber amplifier,” in Proc. of OFC2012, paper OM3C.3 (2012)
Non Patent Literature 2: K. S. Abedin et al., “Cladding-pumped erbium-doped multicore fiber amplifier,” Opt. Express, vol. 20, No. 18, pp. 20191-20200 (2012)
Non Patent Literature 3: T. Sakamoto et al., “Characteristics of Randomly Coupled 12-core Erbium-Doped Fiber Amplifier,” J. of Lightw. Technol., vol. 39, no. 4, pp. 1186-1193 (2021)
Non Patent Literature 4: S. Takasaka et al., “EDF length dependence of amplification characteristics of cladding pumped 19-core EDFA,” in Proc. of OFC2018, paper Th1K.2 (2018)
Non Patent Literature 5: T. Ohara et al., “Over-1000-Channel Ultradense WDM Transmission With Supercontinuum Multicarrier Source,” IEEE J. Lightw. Technol., vol. 24, pp. 2311-2317 (2006)

### SUMMARY OF INVENTION

### Technical Problem

An object of the present disclosure is to reveal a structural condition of an amplification optical fiber capable of amplifying L-band signal light for propagation through a multicore fiber and, thereby, to provide an optical amplifier capable of amplifying L-band signal light for propagation through a multicore fiber.

### Solution to Problem

The present disclosure solves the above problem and provides an amplification optical fiber and an optical amplifier capable of amplifying L-band signal light.

An amplification optical fiber according to the present disclosure is an amplification optical fiber doped with a rare earth element, the amplification optical fiber including:

a first cladding enclosing cores of the amplification optical fiber and a second cladding enclosing the first cladding,

in which the two or more cores are disposed inside the first cladding in a cross section of the amplification optical fiber, and

a core cladding ratio Rcc, which is a ratio of a sum of areas of the two or more cores and a sum of areas of the two or more cores to the first cladding in the cross section of the amplification optical fiber, is 0.0095<Rcc<0.11.

An optical amplifier according to the present disclosure includes: the amplification optical fiber according to the present disclosure;

a pump light source for output of pump light for exciting the rare earth element, with which the amplification optical fiber is doped; and

a pump light combiner for injection of the pump light, from the pump light source, into the first cladding region.

A method of the present disclosure is a method for controlling the optical amplifier of the present disclosure, the method including:

adjusting a length of the amplification optical fiber to amplification of signal light having a wavelength of 1565 nm or more and 1610 nm or less.

### Advantageous Effects of Invention

The amplification optical fiber of the present disclosure is capable of providing an optical amplifier capable of amplifying L-band signal light for propagation through a multicore fiber.

### BRIEF DESCRIPTION OF DRAWINGS

FIG. 1A illustrates a configuration example of an optical amplifier of the present disclosure.

FIG. 1B illustrates a configuration example of the optical amplifier of the present disclosure.

FIG. 2 illustrates a configuration example of a connector between an amplification optical fiber and a transmission path optical fiber.

FIG. 3 illustrates a configuration example of a pump light combiner.

FIG. 4 illustrates an example of a cross-sectional structure of the amplification optical fiber of the present disclosure.

FIG. 5 indicates an example of amplification characteristics of the amplification optical fiber of the present disclosure.

FIG. 6 indicates examples in regard to the number of cores, a core radius, and a cladding diameter of the amplification optical fiber according to the present disclosure.

FIG. 7 indicates calculation results of light conversion efficiency at various amounts of erbium dopant changed in the amplification optical fiber in the present disclosure.

### DESCRIPTIONS OF EMBODIMENTS

Embodiments of the present disclosure will be described in detail below with reference to the drawings. Note that the present disclosure is not limited to the following embodiments. These examples are merely examples, and the present disclosure can be implemented in a form with various modifications and improvements based on the knowledge of those skilled in the art. Note that components having the same reference numerals in the present specification and the drawings are the same components.

### First Embodiment

Hereinafter, an embodiment of the present invention will be described with reference to the drawings.

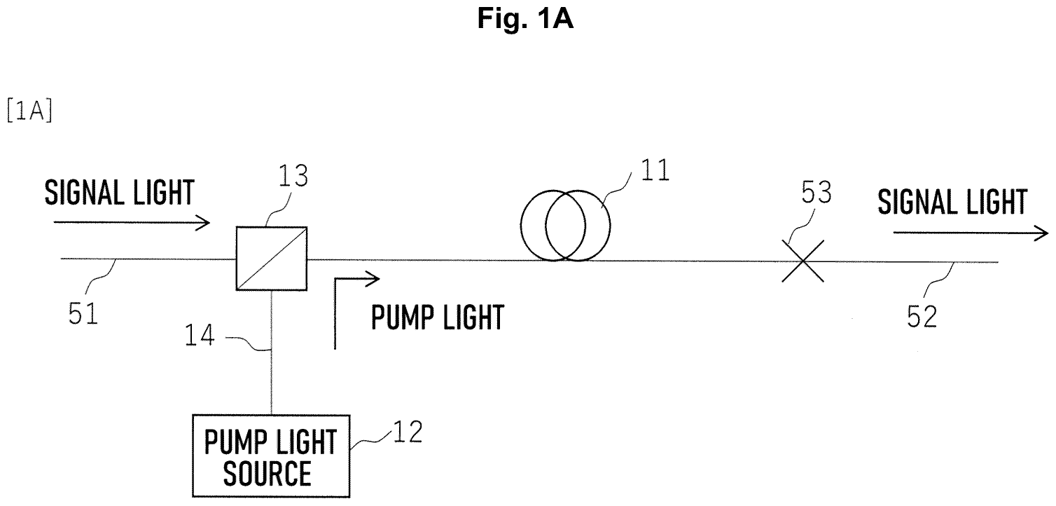

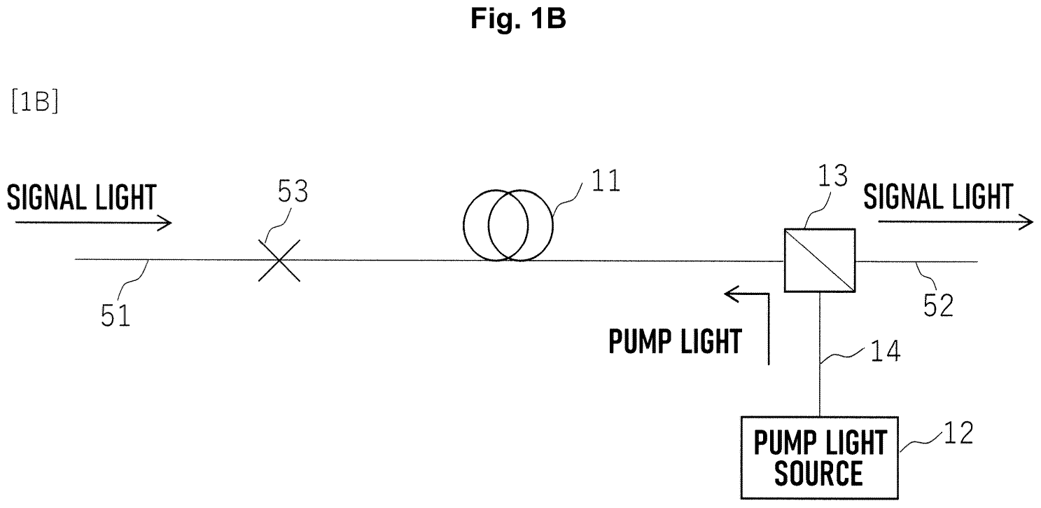

FIGS. 1A and 1B illustrate configuration examples of an optical amplifier according to the present disclosure. A pump light combiner 13 that multiplexes pump light from a pump light source 12 is connected to either an input end or an output end of an amplification optical fiber 11 doped with a rare earth element and the amplification optical fiber 11 amplifies signal light guided through a core thereof.

In general, for the sake of injection of multimode light, emitted from the pump light source 12, into a cladding region of the amplification optical fiber 11, a multimode fiber 14 having a core having a diameter of 105 μm is connected between the pump light source 12 and the pump light combiner 13.

Note that an isolator, which is typically connected to the input end or the output end of the amplification optical fiber 11 in accordance with a propagation direction of signal light, is omitted in this drawing. In addition, a residual pump light remover may be installed to emit pump light, not absorbed into the amplification optical fiber 11, out of the amplification optical fiber 11.

FIG. 1A illustrates a forward pumping type in which pump light is injected into an input side of signal light. In the forward pumping type, the pump light combiner 13 is connected to the input end of the amplification optical fiber 11, and a core connector 53 is connected to the output end of the amplification optical fiber 11. The pump light combiner 13 injects signal light, from each core included in the transmission path optical fiber 51, into the corresponding core of the amplification optical fiber 11. Furthermore, the pump light combiner 13 injects pump light, from the pump light source 12, into a cladding region of the amplification optical fiber 11. The core connector 53 outputs signal light, from each core of the amplification optical fiber 11, to the corresponding core of the transmission path optical fiber 52.

FIG. 1B illustrates a backward pumping type in which pump light is injected into an output side of signal light. In the backward pumping type, the core connector 53 is connected to the input end of the amplification optical fiber 11, and the pump light combiner 13 is connected to the output end of the amplification optical fiber 11. The core connector 53 gets signal light, from each core included in the transmission path optical fiber 51, entering the corresponding core of the amplification optical fiber 11. The pump light combiner 13 injects pump light, from the pump light source 12, into the cladding region of the amplification optical fiber 11. Furthermore, the pump light combiner 13 outputs signal light, from each core of the amplification optical fiber 11, to the corresponding core of the transmission path optical fiber 52.

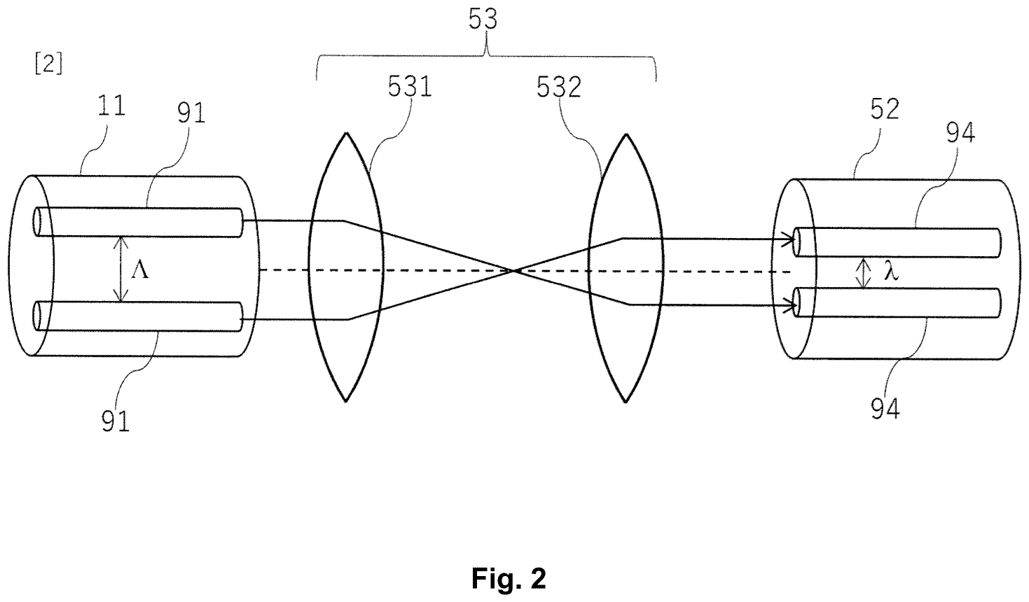

FIG. 2 illustrates a configuration example of a connector 53 between the amplification optical fiber and the transmission path optical fiber. This drawing illustrates an example of the forward pumping type. In the present disclosure, the transmission path optical fibers 51 and 52 are multicore fibers, and the amplification optical fiber 11 is also a multicore fiber having the same number of cores as that of the transmission path optical fiber 51. Thus, in the present embodiment, the connector 53 includes lenses 531 and 532. The lenses 531 and 532 couple each signal light beam, propagating through each core 91 of the amplification optical fiber 11, to the corresponding core 94 of the transmission path optical fiber 52 on the output side.

Here, a core pitch Λ of the amplification optical fiber 11 may be different from a core pitch λ of the transmission path optical fiber 52. In this regard, the amplification optical fiber 11 and the transmission path optical fiber 52, which have different core pitches, can be connected by adjusting focal lengths and arrangement positions of the lenses 531 and 532.

Even in the backward pumping type, the configuration same as the configuration of the connector 53 in the forward pumping type can be used with the configuration of the transmission path optical fiber 52 replaced with the configuration of the transmission path optical fiber 51. Furthermore, the connector 53 of the present embodiment is not limited to the connector 53 of a space system, and can have any configuration suitable for an environment of the transmission path.

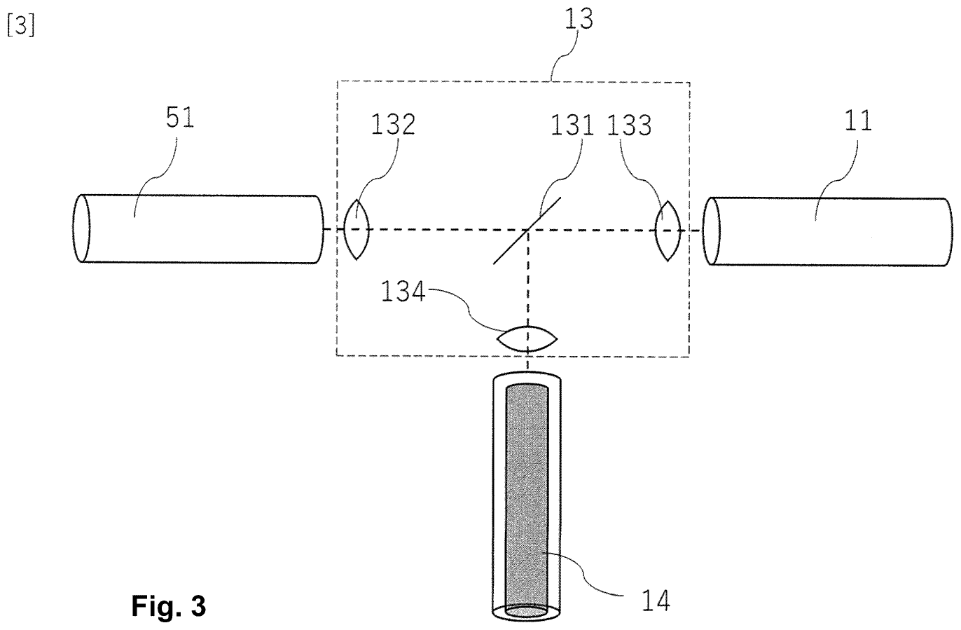

FIG. 3 illustrates a configuration example of the pump light combiner 13. This drawing illustrates an example of the forward pumping type. The pump light combiner 13 includes a dichroic mirror 131 and lenses 132, 133, and 134. The dichroic mirror 131 is disposed on an optical path between an output end of the transmission path optical fiber 51 and the input end of the amplification optical fiber 11 and couples pump light, from the multimode fiber 14, to the input end of the amplification optical fiber 11. As a result, the signal light from the transmission path optical fiber 51 and the pump light from the multimode fiber 14 are injected into the amplification optical fiber 11.

Here, when the amplification optical fiber 11 is a multicore fiber, the core pitch of the amplification optical fiber 11 may be different from the core pitch of the transmission path optical fiber 51. In this regard, the pump light combiner 13 can connect the transmission path optical fiber 51 and the amplification optical fiber 11, which have different core pitches, by adjusting focal lengths and arrangement positions of the lenses 132 and 133.

Even in the backward pumping type, the configuration same as the configuration of the pump light combiner 13 in the forward pumping type can be used with the configuration of the transmission path optical fiber 51 replaced with the configuration of the transmission path optical fiber 52. In addition, the pump light combiner 13 of the present embodiment is not limited to the pump light combiner 13 of the space system, and can have any configuration suitable for the environment of the transmission path.

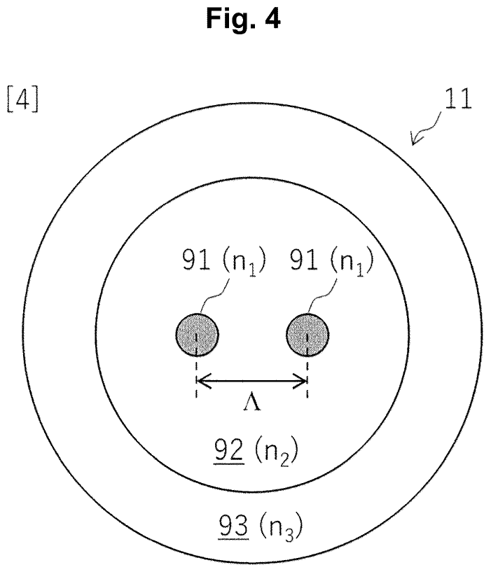

FIG. 4 illustrates an example of a cross-sectional structure of the amplification optical fiber according to the present embodiment. The amplification optical fiber 11 according to the present embodiment includes a cladding 92 enclosing cores 91 and a cladding 93 enclosing the cladding 92, and the two or more cores 91 are disposed inside the cladding 92 in a cross section of the amplification optical fiber 11. Although FIG. 4 illustrates a cross-sectional view of a multicore optical fiber having two cores 91, the alternative thereto can be an optical fiber having three or more cores constituting, with core arrangement, a square lattice geometry, a hexagonal close-packed structure or an annular geometry.

The amplification optical fiber 11 includes a region of the core 91 having a refractive index of n₁ and a region of the cladding 92 having a refractive index of n₂, where n₁>n₂. The condition of n₁>n₂ in the structure of the drawing can be achieved by adding at least one of an impurity that increases the refractive index or an impurity that reduces the refractive index to pure quartz glass as a material of each region. Examples of the impurity that increases the refractive index include germanium (Ge), aluminum (Al), and phosphorus (P). Examples of the impurity that reduces the refractive index include fluorine (F) and boron (B). The core pitch is defined as Λ.

In addition, the amplification optical fiber 11 according to the present disclosure includes the second cladding 93 having a refractive index lower than that of the cladding 92, and the cladding 92 enclosing the core 91 is referred to as a first cladding, and the cladding 93 enclosing the first cladding is referred to as a second cladding. Although the cladding 93 is generally a resin having a refractive index lower than that of the cladding 92, the cladding 93 may be a fluorine-doped glass cladding having a refractive index lower than that of the cladding 92, or the like.

In the amplification optical fiber 11, a rare earth element as a dopant is located within part or the entire region of the core 91 or a region around the core 91 including the claddings 92 and 93.

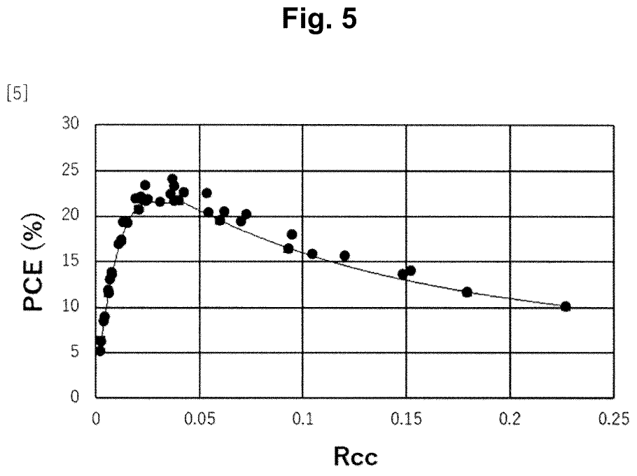

FIG. 5 indicates an example of amplification characteristics of the amplification optical fiber 11. In this example, calculation is performed in accordance with a model of a multicore fiber amplifier described in Non Patent Literature 2. A vertical axis represents light power conversion efficiency (hereinafter, may be referred to as PCE) and is defined by the following equation where pump light power is set as Pₚ, input signal light power is set as Pₛ₀, and output signal light power is set as Pₛ1.

$$\begin{matrix}[ Math . 1 ] & \\ PCE = \frac{{P}_{s 1} - {P}_{s 0}}{{P}_{p}} & ( 1 )\end{matrix}$$

In the drawing, the PCE obtained by the above equation is multiplied by 100 and expressed in units of %. A horizontal axis represents a core cladding ratio Rcc, which is a ratio of an area of the core 91 to an area of the cladding 92 in the amplification optical fiber 11. In addition, a curve in the drawing is a boundary line indicating a PCE lower limit of a calculation result. The area of the cladding under this condition indicates the area of the cladding through which the pump light is guided and is defined by a sum of the area of the core 91 and the area of the cladding 92 in the present embodiment. In a multicore fiber having two or more cores 91, the area of the core is defined by the sum of areas of the two or more cores 91.

In this calculation, the signal is a four-wave WDM signal having signal wavelengths of 1530, 1540, 1550, and 1565 nm, and input signal light power Pₛ₀ per core 91 is −6 dBm. In order to amplify an L band, an EDF length is set to 80 m, a pump light wavelength is set to 980 nm, and pump light power Pₚ is set to 50 W. An amount N₀ of erbium dopant to the core 91 was set to 6×10²⁴ ions/m³. In the drawing, the core cladding ratio Rcc is calculated by changing value of the number of cores, the core radius, and the cladding diameter within the ranges of 2 to 12 μm, 1 to 6.5 μm, and 70 to 150 μm, respectively.

As can be seen from the drawing, in the optical amplifier that amplifies the cladding pumping L-band signal light, obtaining a high PCE requires a specific Rcc range. This means that the optical amplifier, unlike the C-band optical amplifier, cannot produce highly efficient amplification by simply increasing Rcc.

According to Non Patent Literature 3, a maximum of the PCE is 10% with regard to the C-band optical amplifiers reported so far. The present embodiment capable of achieving 15% PCE, which is 1.5 times as high as that of the C-band optical amplifiers, and then the Rcc falls within a range of 0.0095<Rcc<0.11.

Alternatively, more preferably, this embodiment is capable of achieving 20% PCE, which is 2.0 times as high as that of the C-band optical amplifiers. Then, the Rcc falls within a range of 0.0175<Rcc<0.055.

The boundary line indicating the PCE lower limit of the calculation result in FIG. 5 is determined by the following equation.

(i) in regards to Rcc<0.04

$$PCE = 713730 \times R c {c}^{3} - 66289 \times R c {c}^{2} + 2025.3 \times Rcc + 1.1 786$$

(ii) in regards to Rcc≥0.04,

$$PCE = - 82 \; 0.5 \times R c {c}^{3} + 576.99 \times Rc {c}^{2} - 165.28 \times Rcc + 27. 557$$

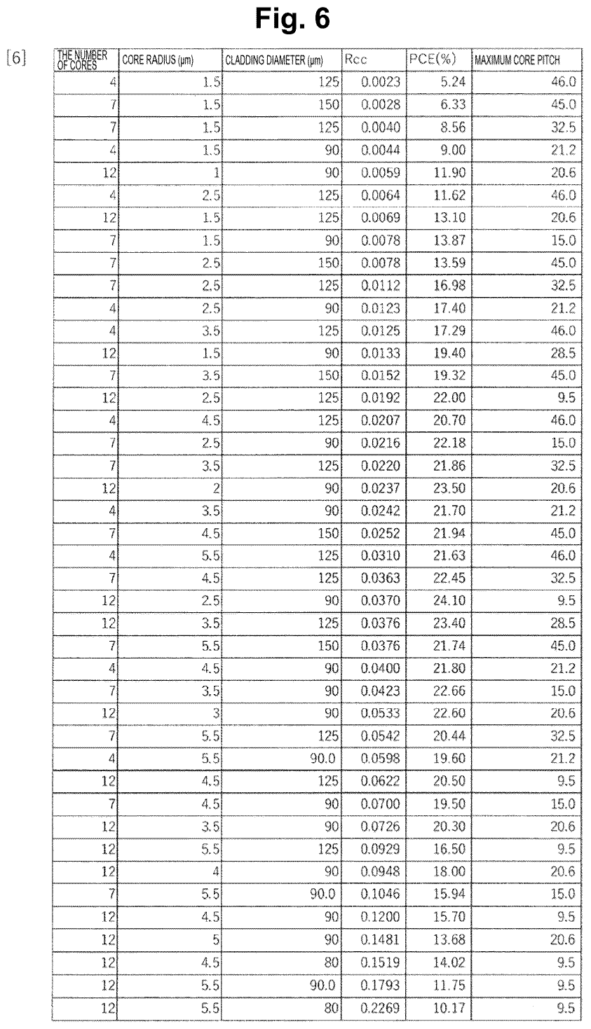

The number of cores, the core radius, and the cladding diameter of the MCF assumed in FIG. 5 are expressed in FIG. 6. In this calculation, the amount N₀ of erbium dopant is fixed to 6×10²⁴ ions/m³, but the aforementioned Rcc range does not change even with other addition amounts.

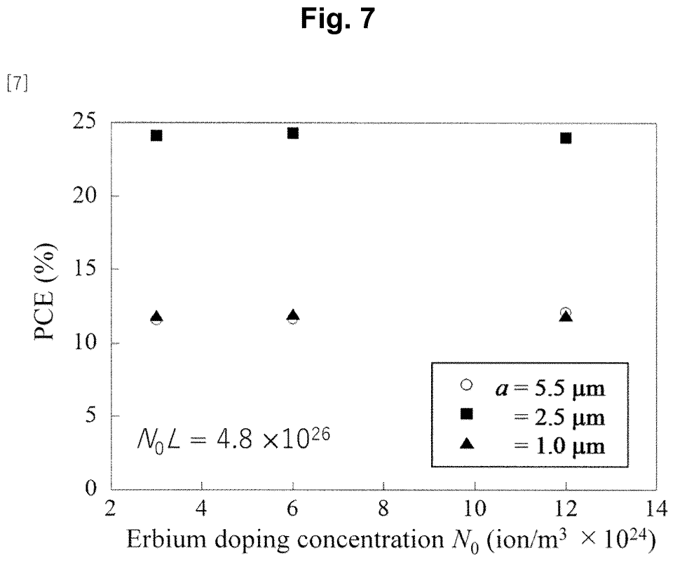

FIG. 7 indicates calculation results of PCE at the amount N₀ of erbium dopant. The number of cores is 12, and the core radius is changed to 1.0 μm, 2.5 μm, and 5.5 μm. When the amount N₀ of erbium dopant increases or decreases, changing the EDF length is necessary in order to obtain equivalent amplification characteristics, and in this calculation result, a product of N₀ and the EDF length L is set to a constant that is 4.8×10²⁶ (ions/m²). From the drawing, the characteristics of PCE can be understood to be unchanged by adjusting the EDF length to obtainment of equivalent amplification characteristics even when the amount N₀ of erbium dopant is one of all the possible amounts. In other words, the aforementioned Rcc range for obtaining a high PCE in the L-band optical amplifier does not change.

Note that, in the MCF structures in related art described in Non Patent Literatures 1 and 4, the design is based on a non-coupled multicore structure, and thus, the core pitch is 30 μm or more, and accordingly, the cladding diameter tends to be large and the Rcc tends to be small. Thus, such a design region is considered to be a region of Rcc<0.04 where the PCE increases in accordance with increase of Rcc, even considered to be a region limited below the Rcc range disclosed in the present disclosure. Thus, it can be said that the present disclosure cannot be easily inferred from the study results so far.

### Second Embodiment

Regarding an attempt to achieve the desired Rcc range, the core pitch of 30 to 40 μm, which is a typical core pitch in the non-coupled MCF design, may enlarge the cladding diameter, and may fail in the attempt to achieve the desired Rcc. FIG. 6 illustrates a maximum value of the core pitch that can be designed with a cladding thickness, which is the shortest distance from the center of the outermost core to the cladding boundary, set to 30 μm. The cladding thickness was set to the value of Non Patent Literature 3. In the Rcc range defined in the present disclosure, designing the core pitch Λ of 30 μm or less is necessary in many cases, and the design by the non-coupled MCF design is impossible of achievement. Thus, it can be said that a coupled MCF that allows inter-core crosstalk is desirable.

In general, in order to ensure sufficient transmission quality in an optical communication system, it is desirable to set power penalty to 1 dB or less, and for this purpose, the crosstalk needs to be set to −26 dB or less as described in Non Patent Literature 5. In other words, the coupled MCF is defined as an optical fiber having inter-core crosstalk of −26 dB or more. In the reports so far, the MCF is a non-coupled MCF (Non Patent Literatures 1 and 4), or a coupled MCF having an Rcc limited to 0.11 or more (Non Patent Literature 3), which deviates from the scope of the present disclosure.

The inter-core crosstalk is determined on the basis of a coupling coefficient κ. The calculation of κ is generally obtained by the following equation.

$$\begin{matrix}[ Math . 2 ] & \\ κ = \frac{ω {ε}_{0} \int {\int }_{- ∞}^{∞} ( {N}^{2} - {N}_{2}^{2} ) {E}_{1}^{*} \cdot {E}_{2} dxdy}{4 P} & ( 2 )\end{matrix}$$

Here, ω is an angular frequency, ε₀ is a dielectric constant in vacuum, E₁ and E₂ are electric field distributions of a propagation mode for guiding through a core of interest and a propagation mode for guiding through an adjacent core, respectively, N is a refractive index distribution of a multicore fiber, N₂ is a refractive index distribution on the assumption that only a core whose electric field distribution is E₁ is present, and P is signal light power of the propagation mode of the core of interest.

When the refractive index of the core 91 is a step type, the coupling coefficient κ is calculated by the following equation.

$$\begin{matrix}[ Math . 3 ] & \\ κ = \frac{\sqrt{Δ}}{a} \frac{{u}^{2}}{{V}^{3} {K}_{1}^{2} ( w )} {( \frac{π a}{w Λ} )}^{1 / 2} exp ( - \frac{w}{a} Λ ) & ( 3 )\end{matrix}$$

Here, a is a radius of the core 91, Δ is a relative refractive index difference between the core 91 and the cladding 92, u is a normalized lateral propagation constant, w is a normalized lateral attenuation constant, Λ is a core pitch, V is a normalized frequency, and K₁ is a modified Bessel function of the second kind.

In other words, the inter-core crosstalk can be adjusted by the core structure, such as the core radius a or the relative refractive index difference Δ, and the core pitch Λ between the adjacent cores, and the MCF design in which the inter-core crosstalk is set to −26 dB or more by optimizing these structures can be implemented by the relevant business operator.

Regarding adjustment of an amplification band of the optical amplifier, for example, an erbium-doped optical fiber having a typical length of approximately 10 m, as described in Non Patent Literature 4, can bring about characteristics of amplifying the C band are obtained, and a length several times as long as the above length (for example, 60 to 100 m) can get the amplification band shifting to the L band, and the L band amplifier can be implemented. As specific procedure, the L-band optical amplifier can be achieved through procedure in which the length of the amplification optical fiber 11 is increased with the amplification band confirmed, or the fiber length is shortened with the amplification band confirmed using the sufficiently long amplification optical fiber 11, and an optimum fiber length is obtained with desired amplification obtained in the L-band wavelength band of 1565 nm or more and 1610 nm or less.

As described above, the optical amplifier of the present disclosure can efficiently amplify the L-band signal light. Thus, the present disclosure can achieve a highly efficient optical amplifier for amplifying L-band signal light for space division multiplexing.

### INDUSTRIAL APPLICABILITY

The present disclosure can be applied to an information communication industry.

### REFERENCE SIGNS LIST

11 Amplification optical fiber
12 Pump light source
13 Pump light combiner
131 Dichroic mirror

### 132, 133, 134 Lens

14 Multimode fiber
51, 52 Transmission path optical fiber

### 53 Connector

### 531, 532 Lens

### 91 Core

### 92, 93 Cladding

1. An amplification optical fiber doped with a rare earth element, the amplification optical fiber comprising:
a first cladding enclosing cores of the amplification optical fiber and a second cladding enclosing the first cladding,
wherein the two or more cores are disposed inside the first cladding in a cross section of the amplification optical fiber, and
a core cladding ratio Rcc, which is a ratio of a sum of areas of the two or more cores to a sum of areas of the two or more cores and the first cladding in the cross section of the amplification optical fiber, is 0.0095<Rcc<0.11.

2. The amplification optical fiber according to claim 1,
wherein the two or more cores constitute a core structure and a core pitch in which crosstalk between the cores is −26 dB or more.

3. An optical amplifier comprising:
the amplification optical fiber according to claim 1;
a pump light source for output of pump light for exciting the rare earth element, with which the amplification optical fiber is doped; and
a pump light combiner for injection of the pump light, from the pump light source, into the first cladding.

4. The optical amplifier according to claim 3,
wherein the amplification optical fiber amplifies signal light, having a wavelength of 1565 nm or more and 1610 nm or less, for propagation through the two or more cores.

5. A method for controlling the optical amplifier according to claim 3, the method comprising:
adjusting a length of the amplification optical fiber to amplification of signal light having a wavelength of 1565 nm or more and 1610 nm or less.
